(19) United States
(12) Patent Application Publication
(10) Pub. No.: US 2010/0325560 A1
(43) Pub. Date: Dec. 23, 2010

(54) System and Method for Review of Discussion Content

(76) Inventor: Callan H. Bryan, Cornelius, NC (US)

Correspondence Address: MCNAIR LAW FIRM, P.A., P.O. BOX 447, GREENVILLE, SC, 29602-0447, US

(21) Appl. No.: 12/785,793

(22) Filed: May 24, 2010

Related U.S. Application Data
(63) Continuation-in-part of application No. 12/017,832, filed on Jan. 22, 2008, now abandoned.

(51) Int. Cl. G06F 3/01; G06F 15/16

(52) U.S. Cl. 715/753

(57) ABSTRACT

This invention is a content review system having a computer readable medium which can contain member information embodied in the computer readable medium representing individuals that wish to participate in online discussions where each member has an electronic address. Computer readable instructions provide for receiving initial discussion content generated by an originating member, generating a new discussion notification, transmitting the new discussion notification to the members, receiving a comment to the initial discussion content from a commenting member, transmitting the comment to each member, receiving review information from a reviewing member wherein the review is associated with the comment and wherein the review information include feedback information selected from the group of concur, concur and comment, neutral comment, dissent and dissent and comment, and transmitting the review information to at least one member.

### CLAIM OF PRIORITY

This application claims priority on U.S. patent application Ser. No. 12/017,832 filed Jan. 22, 2008.

### FIELD OF THE INVENTION

This invention is directed to a system and method for evaluating responses to distributed queries and more specifically, to a system and method allowing responses to distributed queries to be reviewed by third parties thereby providing review, including peer review, of discussion content and comments to discussion content.

### BACKGROUND OF THE INVENTION

With modern communications available for mass distribution of information and communications, are many systems that allow individuals that have inquiries to post these queries to either target groups or to the general public. Technologies such as e-mail, mailing lists, list-servs, newsgroups, web forums, blogs, online discussion groups, message forums, and bulletin boards allow information to be posted and distributed to a vast number of individuals and further provide for an individual with a discussion content to present this discussion content to these vast numbers of individuals.

For example, an Internet forum is technology based on the Internet that allows individuals to hold discussions and post content. The content can be in the form of a discussion content, a response or a comment. These Internet forums originate in the advent of the Internet which was used by the academic community to post queries, receive responses and otherwise share information. Internet newsgroups also provided this functionality and were readily found as early as the 1980s. Today, there are thousands if not millions of forums on a vast number of topics. Forums can be used by any number of professionals which can include the legal, medical, accounting, research, academic, government, corporate, military, or any number of other communities which have a need for the exchange of information.

Internet forums are also referred to as web forums, message boards, discussion boards, discussion groups, discussion forums, bulletin boards or simply forums. A forum is essentially a website composed of a number of member-written provided threads. A thread is a discussion or conversation in the form comprised of a series of member-written posts. For example, the initial thread may begin with the inquiry, “What is the best method of treating Rheumatoid Arthritis?” Once the inquiry is posted, there may be any number of responses to this discussion content and even responses and comments to the responses themselves. This initial inquiry and the subsequent responses and comments comprise the thread.

Forums can allow members to post anonymously or can associate the posting with the member's identification information. Members can register with a forum using a username and a password and can be granted varying levels of rights. For example, one user can be allowed to post inquiries and responses while another user may only be allowed to review threads. Anonymous posting can be accomplished by allowing posting without associating the posting with the member's identification information.

In one embodiment, non-members of the forum may be able to received inquiries, post responses and comments and rate comments if the non-member has an email address. Such authority can be equivalent as that of a member or limited in assess to forums, restricted to simply reviewing posting or other limitations disallowing the non-member from enjoying the full benefits of members.

Threads in a forum are generally organized where the postings are displayed in chronological order. However, threads can also be displayed in association with the posting itself.

Some forums feature a point system that allows members to add to the points of another member by providing positive feedback for that member or “propping” that member. Negative feedback can also be provided thereby reducing the number of “points” awarded to that member. For example, eBay allows members to leave positive, neutral or negative feedback for its members thereby creating a “feedback forum.” In eBay's system, feedback ratings are used to determine each member's feedback score. A positive rating adds 1 to the score, a negative rating decreases it by 1, and a neutral rating has no impact. The higher the feedback score, the more positive ratings the member has received from other members.

Forums can also serve an important role in the exchange of information directed to specific industries or professional areas. Individuals and our society are best served by professionals who have access to the “better” information, data or opinions. For example, in the medical industry, patients will be better assisted, diagnosed and advised if the health care provider has access to better information. The use of a forum can provide better access to information by allowing peers in the medical field, for example, to post queries and responses and to allow members of the forums to view the discussion content and responses.

Individuals also use e-mail based “list-serv” that reaches all of the subscribing members individual e-mail addresses. The subscribing members then cull through all of the e-mails for questions or opinions that may interest them. There may be many responses to single discussion content, but the e-mails do not appear in order of the discussion content posed. The responses also are not in any particular order and the advice and opinions expressed vary quite widely from very good to very bad advice.

However, currently there is no system to allow the responses to an inquiry to be subject to peer review. Further, there is no system that ranks the responses according to peer review. Further, there is no system that allows a user to comment on a response to discussion content and then allows for reviews that critique the comments to such discussion content.

Therefore, there is a need to provide for peer review of responses to inquiries. Further, there is a need to provide the reviewer of the discussion content and response with a way to determine the results of the peer review.

### SUMMARY OF THE INVENTION

This invention is a content review system having a computer readable medium and can have a set of member information embodied in the computer readable medium representing individuals that wish to participate in online discussions where each member has an electronic address used to send and receive messages. Computer readable instructions embodied in the computer readable medium for receiving initial discussion content generated by an originating member, generating a new discussion notification, transmitting the new discussion notification to the members, receiving a comment to the initial discussion content from a commenting member, transmitting the comment to each member, receiving review information from a reviewing member wherein the review is associated with the comment and wherein the review information include feedback information selected from the group of concur, concur accompanied with a comment, neutral, neutral accompanied a comment, dissent and dissent accompanied with a comment and transmitting the review information to at least one member.

Concurrence represents that the reviewer agrees that the comment is factually accurate and relevant to the specific discussion. A dissent means that the Review information can also be used to order the comments as displayed to a user. In one embodiment, the comment with the mot number of concurrences and least number of neutral and dissents would be placed first in order. The comment with the most number of dissents and the least number of neutral and concurrences would be placed last. In one embodiment, a concurrence would be assigned a numerical value such as +1, a neutral would be assigned a numerical value such as 0 and a dissent would be assigned a numerical value such as −1. These numerical values would be totaled and the comments can be presented to the user in order of highest numerical value to the lowest. In another embodiment, the numerical value would be assigned

The invention can also include opt-in information embodied in the computer readable medium and associated with the member information representing whether a member wishes to participate in the discussion so that to the computer readable instructions can include instructions for retrieving the opt-in information from the computer readable medium, transmitting the new discussion notification only to members that have selected to opt-in to the discussion, transmitting the comment only to members that have selected to opt-in to the discussion, and transmitting the response information only to members that have selected to opt-in to the discussion. The discussion content, comment and response can be transmitted either in full text within an electronic message or by a link to the information.

The invention can order the comments according to the review information according to a formula selected from one of (C−D)/(C_{T}+D_{T}), (C−D)/(C+D), ((C−D)/(C_{T}))/(C_{T}+D_{T}), (C−D)/(C_{T}−D_{T}), (C−D)/D_{T} and (C+D)/D_{T} where C equals concur and D equals dissent. Additionally, separate values can be assigned to each of concur, concur with comments, neutral (or neutral comments), dissent with comments or dissent.

Member of the invention or user in general of the invention can select to monitor discussion content, comments to the discussion, and the reviews to the comments and will receive only those items that the member or user has requested to be monitored. When posting the discussion content, termination criteria representing when comments to the initial discussion content will cease being received can be included so that members are prevented from posting comments to the discussion content if the termination criteria has been met. Such termination criteria represents when the discussion will terminate and no longer allow members to post questions, comment on answer or comments or rate responses.

In one embodiment, the invention can receive a need more information request from a member representing that the member needs more information prior to commenting to the initial discussion content and can transmit the need more information request to the member who originated the discussion content. In this case, computer readable instructions include instructions can prevent members from posting comments when a need more information request is received.

### DESCRIPTION OF THE DRAWINGS

The invention will be more readily understood from a reading of the following specification and by reference to the accompanying drawings forming a part thereof, wherein an example of the invention is shown and wherein:

FIG. 1 is a schematic showing the invention;

FIG. 2 is a schematic of the data flow of the invention;

FIG. 3 is an illustration of the invention in operation;

FIG. 4 is a flow chart of the invention; and,

FIG. 5 is a flow chart of the invention.

### DESCRIPTION OF THE INVENTION

An object or module is a section of computer readable code embodied in a computer. The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer- or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art. The present invention is a process where members can review electronically posted communications. These reviewers provide feedback associated to the response to a discussion content which is then used to score the response for subsequent reviewers. The reviewers also have the opportunity to add comments to clarify the review indicating why they agree or disagree, what additional information they may need to respond, or with authority to support the position taken by the responder. It is important to note that user of the invention can be members of a community where access to the invention is limited to these members or can be open to any users regardless of whether the member is a member of the community.

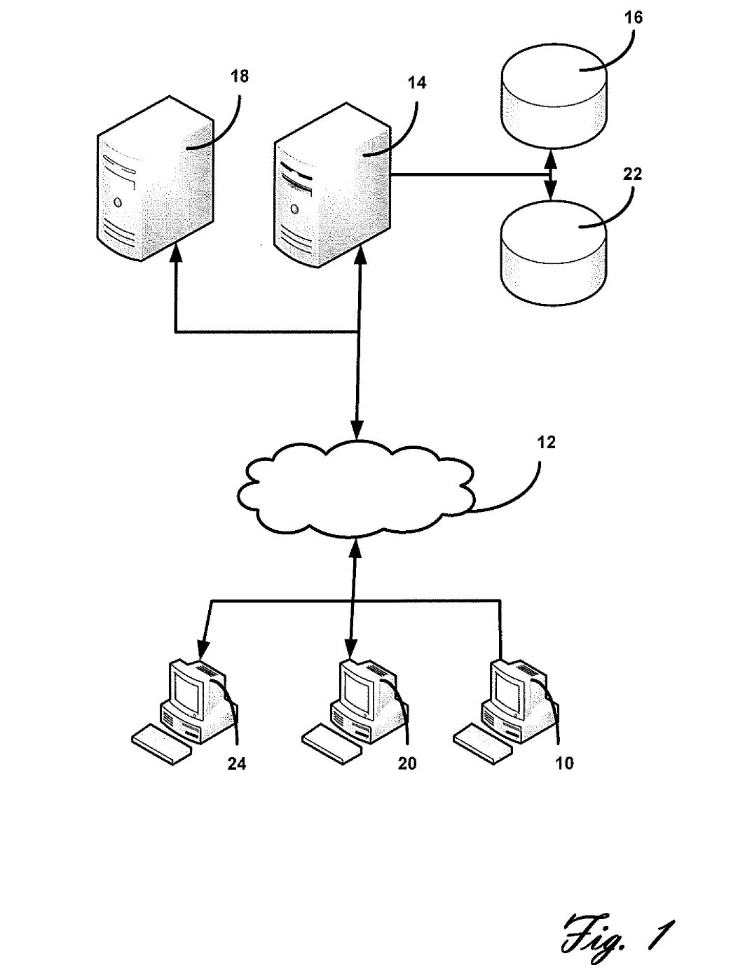

Referring now to FIG. 1, member has a computer terminal 10 and enters a question, statement, opinion, query, etc. (herein “discussion content”) for which the subscriber wants a comment from members. Again, in one embodiment, it is not necessary for the posting user to be a member or for commenting or reviewing users to be members. The discussion content is transmitted through computer network 12 through a data server 14 and the discussion content can be stored in a database 16 communication with server 14. The discussion content has associated sections and is transmitted through e-mail server 18 through network 12 to subscriber 20 who is a subscriber of, opted into, or created the section.

Member of the system can elect to receive notifications when new discussion content is posted and when a comment to discussion content is posted. Members can opt-in to receive all new discussion content for a section, or can select only to receive comments to discussion content selected by the member. In one embodiment, monitoring information can be associated with a member. Monitoring information is information contained in a computer readable medium and associated with the record of a member. Monitoring information tracks whether the and which discussion the member wishes to follow as entries are added.

In one embodiment, an expiration time can be associated with the discussion content so that comments to the discussion content can only be posted for a predetermined period of time. This allows for comments to the discussion content to be limited so that members are only provided a predetermined period of time to provide comments to the discussion content.

Members, using terminal 20, can submit a comment to the discussion content which is transmitted through network 12 to server 14 and can be stored in a database 22 in communication with the server. Once comments are received, a member, using terminal 24, can review the comment and provide a review to the comment. The review information is stored and associated with the comment and can be stored in database 22. Therefore, there can be the steps of the initial discussion content where the original posting member wishes to receive comments to discussion content, comment to the discussion content from other member related to the discussion content and reviews to the comments so that the comments themselves can be responded to by members.

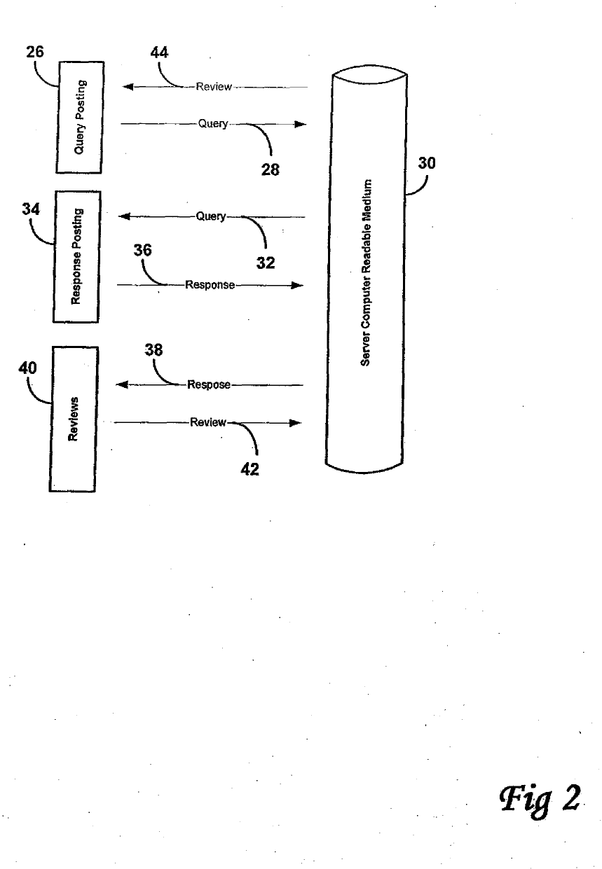

Referring now to FIG. 2, discussion content is transmitted to the server's computer readable medium 30. Computer readable instructions by way of the computer readable medium transmit the discussion content 32 by way of electronic message to members that have selected to receive discussion content for a specific section. The e-mail either contains a hyper-link which allows the member to respond with comments to the discussion content by accessing server's computer readable medium 30 or by e-mail. Comments 36 are then transmitted to the computer readable medium through either an e-mail message or through a website to be stored in computer readable medium 30. Comments 36, or notification of the comments are then transmitted to members or can be accessed by anyone browsing the website in communication with computer readable medium 30 and comments 36 or notification of the comment to the discussion content is sent to reviewer's location 40. A member can then access the comments and provide reviews to the comment which are then transmitted back to the computer readable medium. Reviews 44 can be sent to the originating discussion content member in location 26 so that reviews to the comments can be used to rank the comments and the originating member has the benefit of peer review or review to comments to the initial discussion content.

In one embodiment, the member reviewing comments has the option to review comments through selecting several predetermined options such as concur, concur with comments, neutral comments, dissent and dissent with comments. When a comment receives a concur, the concur value (C) for that comment is increased by one or other predetermined value. When a comment receives a dissent, the dissent value (D) for that comment increases by one or other predetermined value. In one embodiment, the value for a Concur or Dissent with Comments is ½ the Peer Value of an unconditioned Concur or Dissent. The peer review value can be calculated by dividing the number of concurrences by the sum of the concurrence value and dissent value. Therefore, the peer value (P) is calculated by C/(C+D). The comments can then be displayed in order of the peer value. For example, the comments that have the highest peer value, and therefore the most concurrences, can be displayed at the top of the list of comments to the discussion content.

In one embodiment, the peer value can be calculated by dividing the concurrence value less the dissent value for the particular comment by the sum of all concurrence values (C_{T}) and the dissent values (D_{T}) for all comments. This is expressed by the formula (C−D)/(C_{T}+D_{T}). Therefore, the peer value is a function of not only the sum of concurrences, but a calculation based upon the total number of concurrences and dissents. In one embodiment, the concur review can be awarded a value of 1, concur with comments can be awarded a value of 1.5, neutral can be awarded a value of 0, dissent with comments can be awarded with a value of −1.5 and dissent can be awarded with a value of −1.

Further, the peer value can be calculated by subtracting the dissent value for that question from the concurrence value and dividing that number by the number of concurrences and dissents for that comment. This calculation is illustrated by the formula: (C−D)/(C+D).

In another embodiment, the peer value can be calculated by dividing the concurrence less the dissents for each comment by the total number of concurrence values for all comments. This is represented by the formula (C−D)/(C_{T}). This calculation can be modified by taking the results of (C−D)/(C_{T}) and dividing it by the total number of concurrences and dissents. The formula for this is ((C−D)/(C_{T}))/(C_{T}+D_{T}).

In another embodiment, the peer value can be calculated by dividing the concurrence less the dissents for each comment by the results of subtracting the total number of dissents from the total number of concurrences. This is illustrated by the formula (C−D)/(C_{T}−D_{T}).

In another embodiment, the peer value can be calculated by dividing the concurrence less the dissents for each comment by the total number of dissents. This is illustrated by the formula (C−D)/D_{T}.

In another embodiment, the peer value can be calculated by dividing the concurrence plus the dissents for each comment by the total number of dissents. This is illustrated by the formula (C+D)/D_{T}.

The comments can be sorted by peer value, inverse peer value, total reviews, number of concurrences or number of dissents.

In one embodiment, an indicator can be added to the display to indicate whether the peer value is greater then 0.5, equal to 0.5 or less than 0.5. This provides a visual indication as to whether the comment received more concurrences than dissents, more dissents then concurrences, or is neutral. In one embodiment, visual indicators can also be displayed when the peer value is above a predetermined value or when the peer value is below a predetermined value. For example, when the peer value is less then 0.25, a yellow or green indication can be displayed. When the peer value is less then 0.05, a red indication can be displayed. Therefore, the member, including the originating discussion content provider, can quickly see which comments to the discussion content have mostly concurrences and which has mostly dissents based upon the review to the comment.

By way of example, the following table is illustrative:

| Comment | Concur | Dissent | Neutral | Total | Peer Value |
|---|---|---|---|---|---|
| C | 20 | 1 | 4 | 21 | 0.95 |
| B | 35 | 4 | 1 | 39 | 0.90 |
| A | 45 | 10 | 2 | 55 | 0.82 |
| D | 10 | 30 | 0 | 40 | 0.25 |
| E | 0 | 80 | 0 | 80 | 0.00 |

As can be seen, five comments (A-E) are provided to discussion content. The respective review information for each comment is shown above. The peer review value is then calculated and the comments are displayed in order of the peer value with the highest valued comment appearing first. In one embodiment, the comments are displayed in order of the Peer Value.

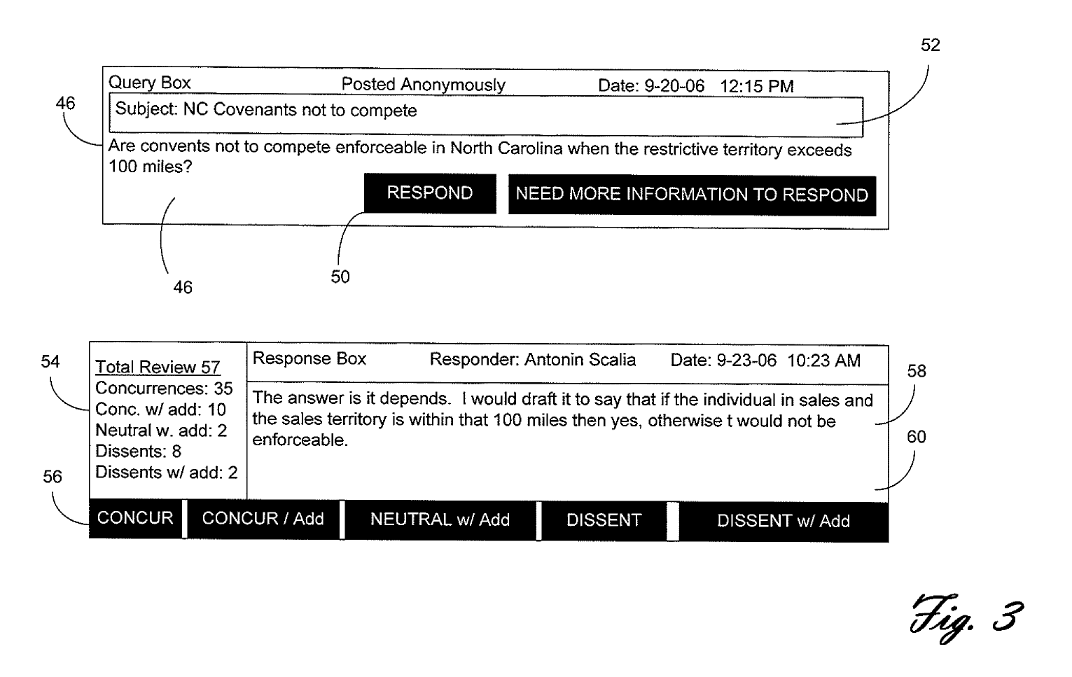

Referring now to FIG. 3, discussion content 46 is posted on the server. Once it is posted, a discussion content box or notification of discussion content is transmitted to members that have selected to receive discussion content. In one embodiment, the discussion content is transmitted to each member without the need for members to opt-in to receive new discussion content.

The discussion content contains the discussion content 48, a button to allow a comment 52, and a button to request more information prior to providing a comment 52. In the event that a member requests additional information prior to providing a comment, the computer readable instructions can prohibit the entry of comments until the originating discussion content provider review the request for more information and either provide more information or allows the discussion content to continue to receive comments, as well as reviews to comments, without modification or additional information to the initial discussion content. In one embodiment, once there is a comment provided for the discussion content, the option of requesting more information can be disabled.

Further, comments are also transmitted to members and the comment box can contain statistics concerning the total number of reviews to the comment at 54, the comment at 58, and a color indicator as to whether there are more concurrences or more dissents by the members who provided reviews to the comment 60 to show visually the “rankings” of the comments. The statistical data at 54 on the comment box can show the members by name or other identifier when the curser is placed over the individual lines of statistical data and can have links to a secondary comment, if any, or information about the subscriber. Review selections 56 are included with the comment box to allow a member reviewing a comment to concur (agree), concur with additional comments (agree with a secondary comment), neutral with additional comments (not agreeing or disagreeing but opening a secondary comment box with additional information, questions, perspectives for other members who review or comment), to dissent (disagree), or to dissent with additional comments (disagree with a secondary comment). In one embodiment, colored backgrounds in the comment boxes can indicate the comment ranking by members. For example, green can be used to show a comment with a majority of reviews being concurrences, grey can be used to show that the majority of reviews to the comment are neutral, and red can be used to show a comment that contains mostly dissents. Further, the comment boxes are ranked in hierarchal order so that the comments that receive the more favorable reviews by the members are higher on the list and the comments that receive the less favorable reviews by the members are lower on the list (see FIG. 3). Thus, the comment at the top of the list has received the most concurrence or has the highest peer value and this comment is more probable than not to be accurate, correct or the best solution for the discussion content posted. The other comments are listed according to rank based on peer value. In another embodiment, members can be allowed to comment or review comments anonymously and the community will determine the weight given to anonymous versus named reviews or comments. In one embodiment, a concurrence or dissent from an anonymous review is afforded a value less than that of a registered member.

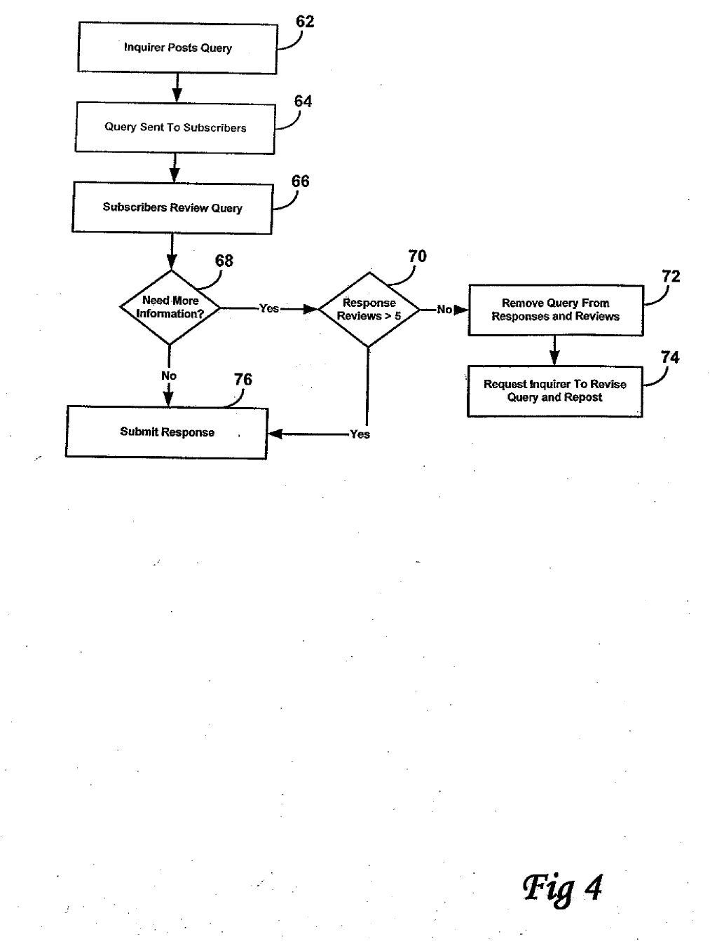

Referring now to FIG. 4, the originating member posts discussion content at step 62. The discussion content is sent to members, or notification is sent to the members in step 64 that the discussion content has been posted. The members can view the discussion content in step 66.

In one embodiment, the members then determine if they need more information from the posting member to comment to the discussion content and prevent a comment by subsequent members in step 68 if such a request is made. If they do not need additional information from inquirer, members then can submit a comment in step 76. If more information is needed from the inquirer, a determination on whether there are more than five comments, reviews of responses or secondary comments to the discussion content in step 70. If there is not more than five, the discussion content is removed from the comment and review process in step 72 and the inquirer is requested by e-mail to revise the discussion content and repost it in step 74. If there are greater than five comments or reviews, then a comment is entered at step 76. In one embodiment, the community can set the number of comments or reviews of comments at step 70, and allow members to request the information desired to the inquirer in the notification e-mail at step 74.

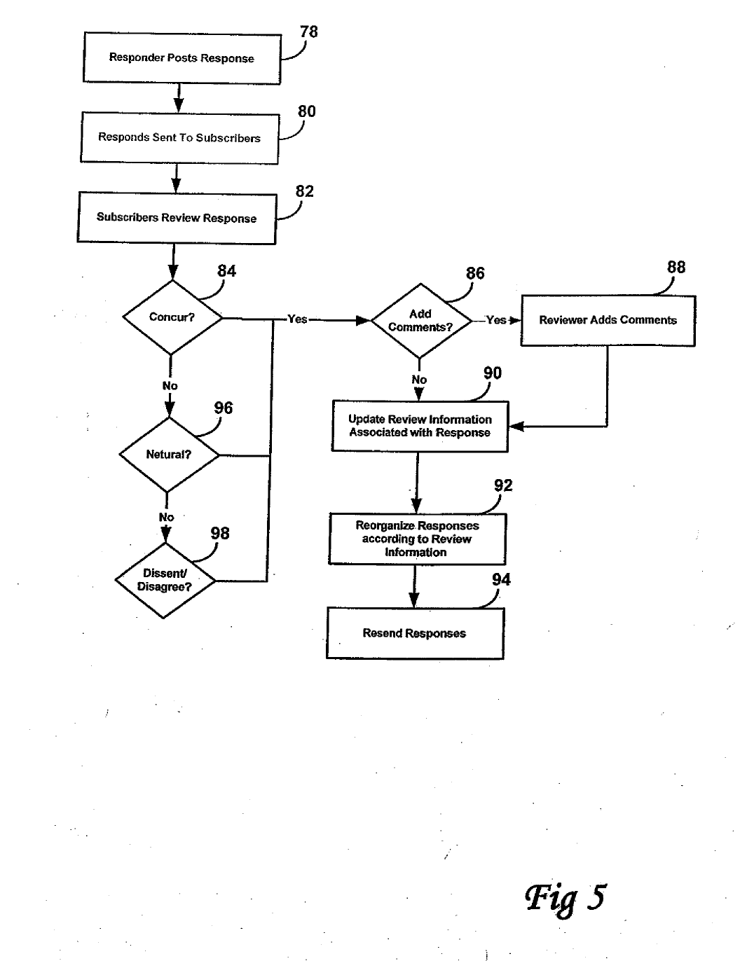

Referring now to FIG. 5, once the member posts a comment to discussion content at step 78, the comment or notice of a comment is sent to members in step 80. If a member concurs with the comment, then a decision is made by the reviewing member as to whether additional comments to qualify the review need to be added at step 86. If the member wishes to add additional comments to the initial comment, a secondary comment box is opened and additional comments are added at step 88. The initial comment is credited with the reviewer's concurrence, neutral or dissent and the review is posted at step 78, along with the comment in the comment box. The review information associated with the comment is updated at step 90 and the comment is reorganized according to the review information in step 92. The reorganized comments or notification of the reviews can be sent to the members in step 94. In one embodiment, the reorganized comments are not sent to the members, but rather maintained on the server for access by the members without being notified of the updates and the review information.

In another embodiment, the members can choose how much activity discussion content gets before the member is notified of comments or reviews. In step 84, if the member does not concur, a decision is made as to whether the reviewer believes there is a neutral comment to be added to the initial comment. If the answer is yes, then neutral content is added at step 86 and a secondary comment box is opened and neutral content is added at step 88, and the process is repeated. If the member does not have neutral comments, the decision is made at step 98 whether there is a dissent or disagreement with the comment, if yes, and then a decision is made as to whether dissent content needs to be added at step 86. If the member wishes to add dissent content to the initial comment, a secondary comment box is opened and dissent content is added at step 88. The comment is credited with the reviewer's concurrence, neutral or dissent and the secondary comment is posted at step 78, along with the initial comment in the secondary comment box and the process is repeated.

When a member receives a new discussion content notification, the member can also transmit the discussion content to another member to see if that receiving member is interested in monitoring, providing comments or providing reviews associated with the discussion content and comments. Therefore, members that are receiving discussion content can “invite” other members to participate in the discussion. In one embodiment, the member receiving discussion content can transmit the new discussion content to a member not opted into the topic non-opted-in member's electronic address. Therefore, the member receiving the discussion content can provide an opportunity to another member to participate or monitor the discussion.

While a preferred embodiment of the invention has been described using specific terms, such description is for illustrative purposes only, and it is to be understood that changes and variations may be made without departing from the spirit or scope of the following claims.

What is claimed is:

1. A review system comprising:
a computer readable medium in communications with a computer processor;
a set of member information stored in said computer readable medium representing individuals that wish to participate in online discussions and having an electronic address associated with each member; and,
a set of computer readable instructions stored in said computer readable medium that, when executed by said processor, perform the steps of receiving initial discussion content generated by an originating member, generating a new discussion notification, transmitting said new discussion notification to said members, receiving a comment to said initial discussion content from a commenting member, transmitting said comment to each member, receiving review information from a reviewing member wherein said review is associated with said comment and wherein said review information include feedback information selected from the group of concur, concur accompanied with a comment, neutral, neutral accompanied a comment, dissent and dissent accompanied with a comment and transmitting said review information to at least one member.

2. The system of claim 1 including:
opt-in information embodied in said computer readable medium and associated with said member information representing whether a member wishes to participate in said discussion; and,
said computer readable instructions include instructions for retrieving said opt-in information from said computer readable medium, transmitting said new discussion notification only to members that have selected to opt-in to said discussion, transmitting said comment only to members that have selected to opt-in to said discussion, and transmitting said review information only to members that have selected to opt-in to said discussion.

3. The system of claim 1 wherein said computer readable instructions for transmitting said new discussion notification to said members includes instructions for transmitting a link to said discussion content to said members rather than transmitting discussion content itself.

4. The system of claim 1 wherein said computer readable instructions include instructions for receiving a plurality of comments to said initial discussion content, receiving a plurality of review information, displaying the said comments in a particular order according to said review information, and transmitting said comments to at least one member with said comments ordered according to said review information.

5. The system of claim 4 wherein said computer readable instructions for ordering said comments according to said review information includes instructions for ordering said comments according to a formula selected from one of (C−D)/(C_{T}+D_{T}), (C−D)/(C+D), ((C−D)/(C_{T}))/(C_{T}+D_{T}), (C−D)/(C_{T}−D_{T}), (C−D)/D_{T} and (C+D)/D_{T}.

6. The system of claim 4 wherein said computer readable instructions include instructions for ordering said comments according to said review information includes instructions for awarding a first value to said comment representing said feedback information of said review information having a review of concur, awarding a second value to said comment representing said feedback information of said review information having a review of concur with comment, awarding a third value to said comment representing said feedback information of said review information having a review of neutral, awarding a fourth value to said comment representing said feedback information of said review information having a review of dissent with comment, awarding a fifth value to said comment representing said feedback information of said review information having a review of dissent, and ordering said comments according to the sum of said first, second, third, fourth and fifth values.

7. The system of claim 1 wherein:
monitoring information is embodied in said computer readable medium and associated with said member information representing whether a member wishes to monitor said discussion, said comments to said discussion, and said reviews to said comments; and,
said computer readable instructions include instructions for retrieving said monitoring information from said computer readable medium and transmitting said new discussion notification only to members that have selected to monitor new discussion content is posted, transmitting said comments only to members that have selected to monitor comments, and transmitting said reviews only to members that have selected to monitor reviews.

8. The system of claim 1 wherein:
said discussion information includes termination criteria representing when comments to said initial discussion content will cease being received; and,
said computer readable instructions include instructions preventing members from posting comments to said discussion content if said termination criteria has been met.

9. The system of claim 1 wherein said computer readable instructions include instructions for receiving a need more information request from a member representing that said member needs more information prior to commenting to said initial discussion content and transmitting said need more information request to said member who originated said discussion content.

10. The system of claim 9 wherein said computer readable instructions include instructions preventing members from posting comments when a need more information request is received.

11. The system of claim 1 wherein said members can store said discussion content, comments and reviews on said computer readable medium for future retrieval.

12. The system of claim 1 wherein said computer readable instructions include instructions allowing members to transmit discussion content to members and non-members having electronic addresses.

13. A review system comprising:
a computer readable medium in communications with a computer processor;
a set of member information representing members that wish to participate in an online discussion stored in said computer readable medium;
a set of discussion content stored on said computer readable medium representing discussion topics of interest wherein at least on discussion topic includes a plurality of comments associated with said discussion content; and,
a set of computer readable instructions stored in said computer readable medium that, when executed by said processor, perform the steps of receiving review information from a reviewing member wherein said review is associated with a comment and wherein said review information include feedback information selected from the group of concur, concur accompanied with a comment, neutral, neutral accompanied a comment, dissent and dissent accompanied with a comment and transmitting said review information to at least one member.

14. The system of claim 13 including:
opt-in information embodied in said computer readable medium and associated with said member information representing whether a member wishes to participate in said discussion; and,
said computer readable instructions include instructions for retrieving said opt-in information from said computer readable medium and transmitting said review information only to members that have selected to opt-in to said discussion.

15. The system of claim 13 wherein said computer readable instructions include instructions for displaying said comments in a particular order according to said review information, and transmitting said comment to at least one member with said comments ordered according to said review information.

16. The system of claim 15 wherein said computer readable instructions for ordering said comments according to said review information includes instructions for ordering said comments according to a formula selected from one of (C−D)/(C_{T}+D_{T}), (C−D)/(C+D), ((C−D)/(C_{T}))/(C_{T}+D_{T}), (C−D)/(C_{T}−D_{T}), (C−D)/D_{T} and (C+D)/D_{T}.

17. The system of claim 15 wherein said computer readable instructions include instructions for ordering said comments according to said review information includes instructions for awarding a first value to said comment representing said feedback information of said review information having a review of concur, awarding a second value to said comment representing said feedback information of said review information having a review of concur with comment, awarding a third value to said comment representing said feedback information of said review information having a review of neutral, awarding a fourth value to said comment representing said feedback information of said review information having a review of dissent with comment, awarding a fifth value to said comment representing said feedback information of said review information having a review of dissent, and ordering said comments according to the sum of said first, second, third, fourth and fifth values.

18. The system of claim 13 wherein:
monitoring information is embodied in said computer readable medium and associated with said member information representing whether a member wishes to monitor said reviews to said comments; and,
said computer readable instructions include instructions for retrieving said monitoring information from said computer readable medium and transmitting said reviews only to members that have selected to monitor reviews.

19. The system of claim 13 wherein:
said set of discussion content includes termination criteria representing when reviews to said comments will cease being received; and,
said computer readable instructions include instructions preventing members from posting reviews to said comments if said termination criteria has been met.

20. The system of claim 13 wherein said members can stores said discussion content, comments and reviews on said computer readable medium for future retrieval.

21. The system of claim 13 wherein said computer readable instructions include instructions allowing members to transmit discussion content, comments and reviews to members and non-members having electronic addresses.

22. A review system comprising:
a computer readable medium in communications with a processor; and,
a set of computer readable instructions stored in said computer readable medium that, when executed by said processor, perform the steps of receiving discussion content from an originating user via a first terminal representing a discussion topic where the originating user wishes to receive comments concerning said discussion content, displaying said discussion content on a second terminal so that commenting users can provide comments directed to said discussion comment, receiving a comment from said commenting users, displaying said discussion comment and said review to said discussion comment on a third terminal so that a reviewing user can provide a review to said comment, and receiving a review to said comment from said reviewing user wherein said review include feedback information selected from the group of concur, concur accompanied with a comment, neutral, neutral accompanied a comment, dissent and dissent accompanied with a comment.

23. The system of claim 22 wherein said computer readable instructions include instructions for transmitting said comment to said originating user.

24. The system of claim 22 wherein said computer readable instructions include instructions for transmitting said review to said commenting users.

25. The system of claim 22 wherein said computer readable instructions include instructions for receiving a plurality of comments to said discussion content, receiving a plurality of reviews for at least one comment, and displaying said comments in an order according to said reviews.

26. The system of claim 25 wherein said computer readable instructions for displaying said comments in order includes instructions for ordering said comments according to a formula selected from one of (C−D)/(C_{T}+D_{T}), (C−D)/(C+D), ((C−D)/(C_{T}))/(C_{T}+D_{T}), (C−D)/(C_{T}−D_{T}), (C−D)/D_{T} and (C+D)/D_{T}.

27. The system of claim 25 wherein said computer readable instructions for displaying said comments in order include instructions for awarding a first value to said comment representing said feedback information of said review information having a review of concur, awarding a second value to said comment representing said feedback information of said review information having a review of concur with comment, awarding a third value to said comment representing said feedback information of said review information having a review of neutral, awarding a fourth value to said comment representing said feedback information of said review information having a review of dissent with comment, awarding a fifth value to said comment representing said feedback information of said review information having a review of dissent, and ordering said comments according to the sum of said first, second, third, fourth and fifth values.

28. The system of claim 22 wherein said computer readable instructions include instructions for receiving termination criteria representing when comments to said discussion content will cease being received and preventing members from posting comments to said discussion content if said termination criteria has been met.

29. The system of claim 22 wherein said computer readable instructions include instructions for receiving a need more information request from a commenting user representing that said commenting user needs more information prior to commenting on to said discussion content and transmitting said need more information request to said originating user.

30. The system of claim 29 wherein said computer readable instructions include instructions preventing users from posting comments when a need more information request is received.

31. The system of claim 22 wherein said users can stores said discussion content, comment and review on said computer readable medium for future retrieval.
